(19) United States
(12) Patent Application Publication
(10) Pub. No.: US 2005/0200486 A1
(43) Pub. Date: Sep. 15, 2005

(54) Patient visual monitoring system

(76) Inventor: Richard S. Greer, Roswell, GA (US)

Correspondence Address: Alexander J. Burke;Intellectual Property Department, 5th Floor, 170 Wood Avenue South, Iselin, NJ, 08830, US

(21) Appl. No.: 10/937,538

(22) Filed: Sep. 9, 2004

Related U.S. Application Data
(60) Provisional application No. 60/552,420, filed on Mar. 11, 2004.

(51) Int. Cl. G08B 23/00

(52) U.S. Cl. 340/573.1

(57) ABSTRACT

A clinical (or other) event triggers automatic video recording of an area in the vicinity of a patient on a DVR (Digital Video Recorder) by a CCTV (Closed Circuit Television) for storage in an Electronic Patient Record (EPR) using coded data (e.g., identifying event type, date, time, duration) and alerts medical personnel to events requiring intervention. A system for remote monitoring of a patient, includes a video camera positioned for monitoring a patient care area. A camera management processor initiates activation of image acquisition by the camera in response to detection of a signal derived in response to a trigger condition. A video recording unit stores data representing acquired video images in response to camera activation.

This is a non-provisional application of provisional application Ser. No. 60/552,420 by R. S. Greer filed Mar. 11, 2004.

### FIELD OF THE INVENTION

This invention concerns a system for monitoring patients to support healthcare delivery.

### BACKGROUND INFORMATION

Patient behavior during healthcare treatment during unsupervised periods in a patient room (care unit), for example, may substantially affect patient medical condition and subsequent recovery or deterioration. Patient behavior that is either deliberate or inadvertent (e.g., unconscious, obsessive, uncontrolled or merely absent minded) may affect patient conformance to a treatment or therapy plan and delay recovery or actively aggravate a patient medical condition. Behavior occurring during unconscious periods such as eye movement, muscle spasms, contortions or other physical motion may also yield important information. Such physical motion may also indicate or comprise an impairment of patient safety. Further, behavior concerning patient self administration of medication may indicate a patient is not taking medication, is overdosing, under-dosing or miss-timing medication ingestion.

Behavior and performance of devices in a patient care unit such as an infusion pump, patient monitoring device or other therapy unit also may substantially affect patient healthcare. In addition, interaction of medical personnel with the patient or with medical devices or patient interaction with devices is also capable of substantially affecting patient treatment and healthcare. Unfortunately, although these types of behavior are of importance to patient treatment, there is usually no record or information available to a treating physician indicating that a healthcare altering behavioral event has occurred. A patient and care unit visual monitoring system according to invention principles addresses this deficiency and related problems.

### SUMMARY OF THE INVENTION

A clinical (or other) event triggers automatic video recording of an area in the vicinity of a patient on a DVR (Digital Video Recorder) by a CCTV (Closed Circuit Television) for storage in an Electronic Patient Record (EPR) using coded data (e.g., identifying event type, date, time and duration) and alerts medical personnel to events requiring intervention. A system for remote monitoring of a patient, includes a video camera positioned for monitoring a patient care area. A camera management processor initiates activation of image acquisition by the camera in response to detection of a signal derived in response to a trigger condition. A video recording unit stores data representing acquired video images in response to camera activation.

### BRIEF DESCRIPTION OF THE DRAWING

FIG. 1 shows a visual patient monitoring system, according to invention principles.

FIG. 2 shows a visual patient monitoring system in a healthcare information network, according to invention principles.

FIG. 3 shows a flowchart of process employed by a visual patient monitoring system, according to invention principles.

### DETAILED DESCRIPTION OF THE INVENTION

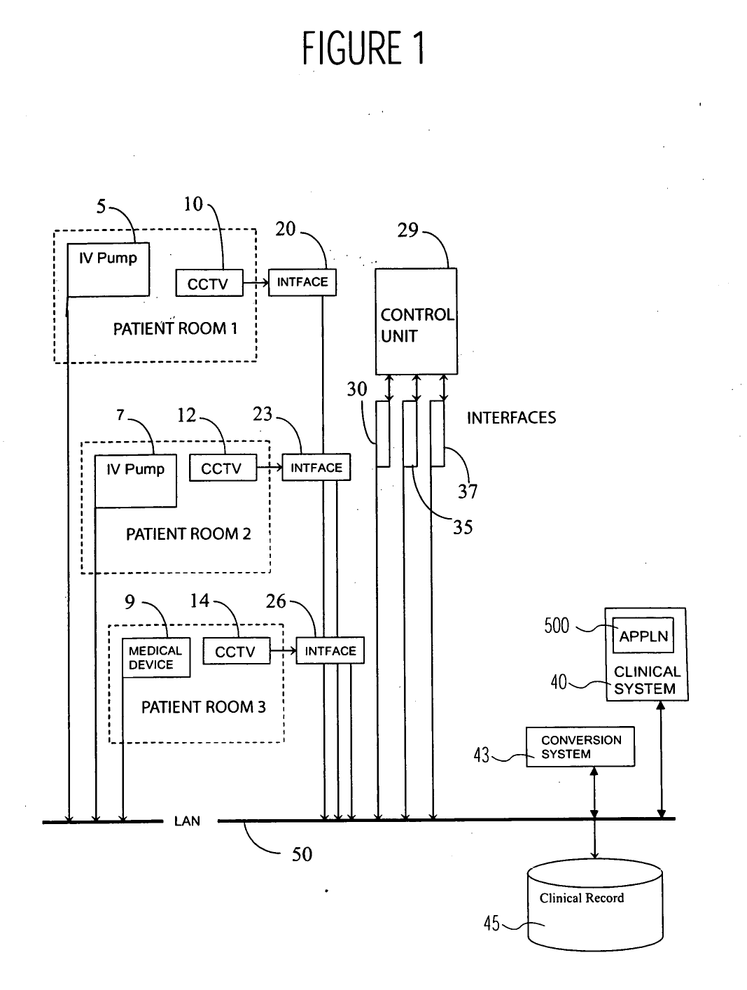

FIG. 1 shows a visual patient monitoring system used in monitoring multiple patients in their respective rooms (care units). A clinical event triggered from a medical device threshold or a trigger event derived from patient movement outside of normal parameters, automatically initiates recording activity in or near a patient's location. Video images and audio data from a CCTV (Closed Circuit Television) or other video camera are stored by a DVR (Digital Video Recorder) and processed to provide an alert signal for communication to a healthcare worker to prompt intervention as required. Video images and associated audio data representing an event are recorded in an Electronic Patient Record (EPR) using coded transactions (type, date, time and duration), for example.

The system provides improves patient safety in a Healthcare facility through video monitoring in response to clinically significant event triggering. Such events include, for example, a medical device threshold being exceeded or patient physical movement in a room. These events potentially yield information of clinical significance upon clinician review at a nursing station or centralized monitoring center or via wired or wireless network communication to a PC, PDA (Personal Digital Assistant), laptop, notebook or other processing device, for example. The system enables determination of different conditions in a patient room including, visual verification that medications are administered appropriately. The system also enables monitoring of patient behavior and provides visual corroboration and verification that a patient call for a nurse is valid, for example. Alarm data from a medical device is also used to trigger visual monitoring and recording of threshold alarm data for later examination and verification, for example.

The system also uses a video camera to remotely monitor displayed patient parameter (vital sign) signals acquired by a patient monitoring device in response to a patient parameter threshold being exceeded. Such patient parameter signals include, electrocardiograph (ECG) data, blood parameter data including blood oxygen saturation data, ventilation parameter data, infusion pump related data, blood pressure data, pulse rate data and temperature data, for example. This enables an infusion pump to be monitored in the middle of the night and supports patient safety and re-location. The video camera also monitors movement in a patient room, e.g., of nurse or patient activity, during a predetermined time interval or after a predetermined time, (such as midnight or third shift). The system records audio and video data in a file associated with a clinical event for communication and storage in an electronic patient record. The video and audio data is reviewed by a clinician to support patient treatment or for other purposes such as in litigation for review and corroboration of an event. Video and audio data of selected events may also be used for medical education of healthcare personnel.

A Medical Device or piece equipment, such as an infusion pump, that transmits serial or ASCII data may be monitored by a system video camera. In such a case, activation of a camera is initiated in response to an infusion pump malfunction or an alert signal notifying a user of a failure of a critical pump, valve or other element. The alert signal is communicated from the pump to a system PC, for example. The camera monitoring system provides visual corroboration of a failing critical infusion pump or valve. Thereby, maintenance personnel are able to remotely see and identify a cracked and leaking pump and inspect a problem in advance enabling appropriate parts and tools to be brought for repair, for example. The video images are communicated via a network such as an intranet or the Internet enabling remote monitoring from any distance. The system is applicable in Healthcare facilities and other facilities that monitor safety of people or critical devices.

A processor as used herein is a device and/or set of machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device. A communication interface processes signals bidirectionally for compatible communication between a source and destination and may use a processor. An executable application comprises code or machine readable instruction for implementing predetermined functions including those of an operating system, healthcare information system or other information processing system, for example, in response user command or input.

FIG. 1 shows a visual patient monitoring system for monitoring patient rooms 1-3. Cameras 10, 12 and 14 in rooms 1, 2 and 3 respectively, monitor the rooms including the vicinity of a patient and associated care devices such as infusion pumps 5 and 7 and medical device 9. Video signals from cameras 10, 12 and 14 are converted from serial to Ethernet compatible data format by interface units 20, 23 and 26 respectively for communication via Local Area Network (LAN) 50 for storage by digital video recorders in control unit 29. Interface units 20, 23 and 26 enable bidirectional communication between cameras 10, 12 and 14 enabling a trigger signal (and other signals) to be conveyed from a medical device in a patient room or central control unit 29 or another network connected device to an individual camera.

Central control unit 29 receives video signals from cameras 10, 12 and 14 for storage in digital video files by digital video recorders. The video signals previously converted from serial to Ethernet compatible data format by interface units 20, 23 and 26 are acquired via LAN 50 and converted by interface units 30, 33 and 37 from Ethernet format to a data format suitable for storage by digital video recorders in control unit 29. The video data conveyed may be digital video data in MPEG2 compatible data format, for example. The MPEG2 (Moving Pictures Expert Group) image encoding standard, is comprised of a system encoding section (ISO/IEC 13818-1, 10 Jun. 1994) and a video encoding section (ISO/IEC 13818-2, 20 Jan. 1995). The video signal data format stored by video recorders in unit 29 may also comprise other data formats including, for example, Hypertext Mark-up Language (HTML) or Standardized Mark-up Language (SGML), GIF, TIFF, JPEG, Internet streamed video and other video data formats and the communication protocol used comprises IP (Internet Protocol) or other communication protocols.

The video digital data stored in files by video recorders in central unit 29 is subsequently communicated via interface units 30, 33 and 37 and LAN 50 to data conversion and exchange unit 43. Unit 43 converts Ethernet compatible video data to a data format compatible with an electronic patient record. The converted video data from unit 43 is communicated for storage in appropriate electronic patient records in repository 45. The video data in electronic patient records in repository 45 is accessed by a user of clinical information system 40. Executable application 500 in unit 40 manages operation of the video system using networked control signals. In other embodiments, managing application 500, may be located in any device on a network linking the video camera and other system components. Clinical information system 40 is employed by a physician to monitor patient behavior, nurse activity or medical device operation in a patient room by accessing video data stored in an electronic patient record in repository 45. Thereby a physician is able to remotely and conveniently observe patient behavior, nurse activity or medical device functioning to verify patient treatment is being implemented as prescribed and occurring in accordance with a predetermined treatment or therapy plan.

Recording of video data produced by an individual camera of cameras 10, 12 and 14 is activated in response to a trigger signal being derived from one or more of a variety of different sources. A trigger signal may be produced by a medical device in response to a predetermined parameter value threshold being exceeded, for example. Such a medical device may comprise, an infusion pump, patient monitoring device, ventilator, blood pressure monitor, pulse monitor, blood oxygen saturation measurement device, incubator or other device in a patient room. The trigger signal may trigger either recording, camera activation or both. A trigger signal may also be derived based on detected movement in a room exceeding predetermined criteria. Such criteria may comprise detected movement exceeding an estimated predetermined distance, a predetermined speed or movement occurring in a predetermined zone in a patient room, for example. The movement is detected using image interpretation and image pixel analysis. A trigger signal may also be generated in response to user command to initiate video recording from a nurse central monitoring station, for example. A trigger signal is conveyed via LAN 50 to digital video recorders in unit 29 and to a camera (such as one of the cameras 10, 12 and 14) via LAN 50 or via wireless communication.

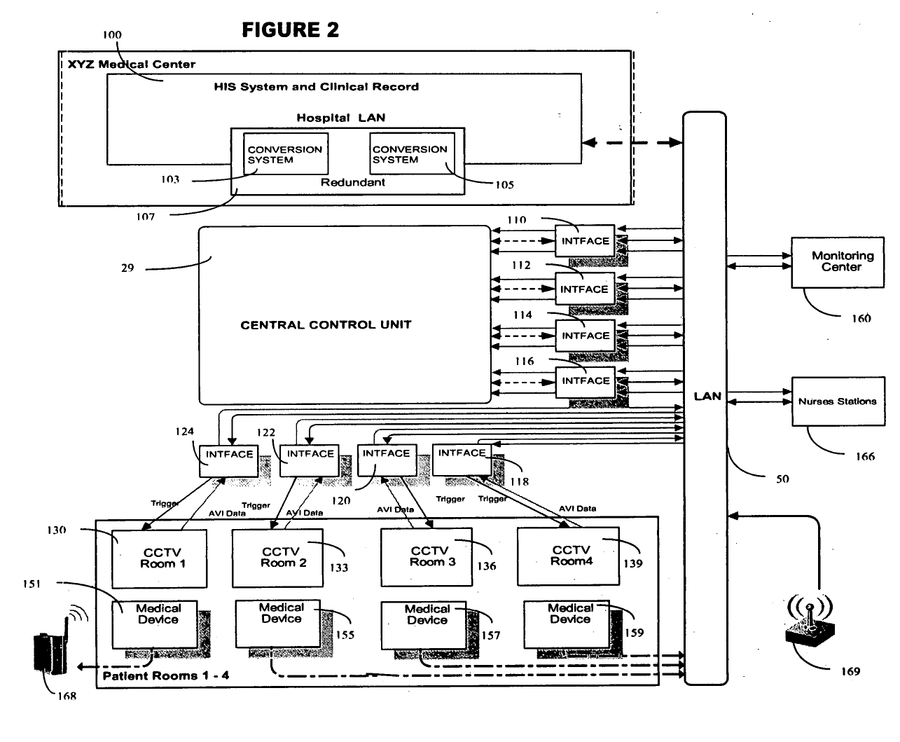

FIG. 2 shows a visual patient monitoring system in a healthcare information network similar to the system of FIG. 1. Cameras 130, 133, 136 and 139 respectively monitor patient rooms 1, 2, 3 and 4 and in particular, the vicinity of a patient and associated care devices 151, 155, 157 and 159 located in the patient rooms 1-4. Video signals from cameras 130, 133, 136 and 139 are converted from serial to Ethernet compatible data format by interface units 118, 120, 122 and 124, for communication via Local Area Network (LAN) 50 for storage by digital video recorders in control unit 29. Interface units 118, 120, 122 and 124 support bidirectional communication between cameras 130, 133, 136 and 139 to enable a trigger signal to be conveyed, from a medical device in a patient room or central control unit 29 or another network connected device, to an individual camera. Medical devices 155, 157 and 159 provide trigger signals suitable for initiating activation of cameras 133, 136 and 139 respectively and storage of corresponding video signals in digital video recorders within central unit 29 by wired connection via LAN 50 in response to a detected trigger condition. Similarly, medical device 151 provides a trigger signal suitable for initiating activation of camera 130 and (or) storage of a video signal in a digital video recorder within central unit 29 by wireless connection via transceiver device 168 and 169 and LAN 50 in response to a detected trigger condition. In other embodiments, the digital video recorders may be located elsewhere on the network linking the system components such as in HIS 100, monitor center 160 or nurses station 166.

Central control unit 29 receives video signals from cameras 130, 133, 136 and 139 for storage in digital video files by digital video recorders. The video signals previously converted from serial to Ethernet compatible data format by interface units 118, 120, 122 and 124 are acquired via LAN 50 and converted by interface units 110, 112, 114 and 116 from Ethernet format to a data format (such as an MPEG2 compatible format) suitable for storage by digital video recorders in control unit 29.

The video digital data stored in files by video recorders in central unit 29 is subsequently communicated via interface units 110, 112, 114 and 116 and LAN 50 to a data conversion and exchange unit 107. Dual redundant conversion and exchange systems 103 and 105 in unit 107 are provided. Back up secondary conversion and exchange system 105 is available in the event of a failure of first primary conversion and exchange system 103. Data conversion and exchange unit 107 converts video data in a data format (e.g., MPEG format) stored by a video recorder within unit 29 to a data format compatible with an electronic patient record within Hospital Information System (HIS) 100. Data conversion and exchange unit 107 also communicates the converted video data, in the data format compatible with an electronic patient record, for data storage in the electronic patient records in a repository within HIS 100. For this purpose unit 107 uses a communication protocol (e.g., IP) selected to be compatible with a network in HIS 100. The converted video data is communicated using the selected communication protocol to the storage repository in HIS 100 via a LAN within HIS 100 or via another type of network such as a WAN (Wide Area Network, intra-net or the Internet.

The video data in electronic patient records in a repository HIS 100 is accessed by a user of HIS 100 such as a physician, clinician or nurse to remotely monitor patient behavior, nurse activity or medical device operation in a patient room either substantially in real time as it occurs or subsequently on-demand. Thereby a physician or nurse can identify a variance of patient treatment from a predetermined treatment or therapy plan and initiate alternative treatment or corrective action. The video data in electronic patient records in the HIS 100 repository is also accessible by a nurse via LAN 50 at nurse station 166. Nurse station 166 is a centralized control area holding records, medications and medical equipment, for example, used by one or more nurses to administer treatments to a group of patients in a hospital floor, wing, department, annex or group of designated care units. The video data in electronic patient records in the HIS 100 repository is also accessible by a nurse via LAN 50 at monitoring center 160. Monitoring center 160 is used by healthcare workers (administrators, or clinicians) to monitor patients in a hospital floor, department, wing or an entire hospital, for example.

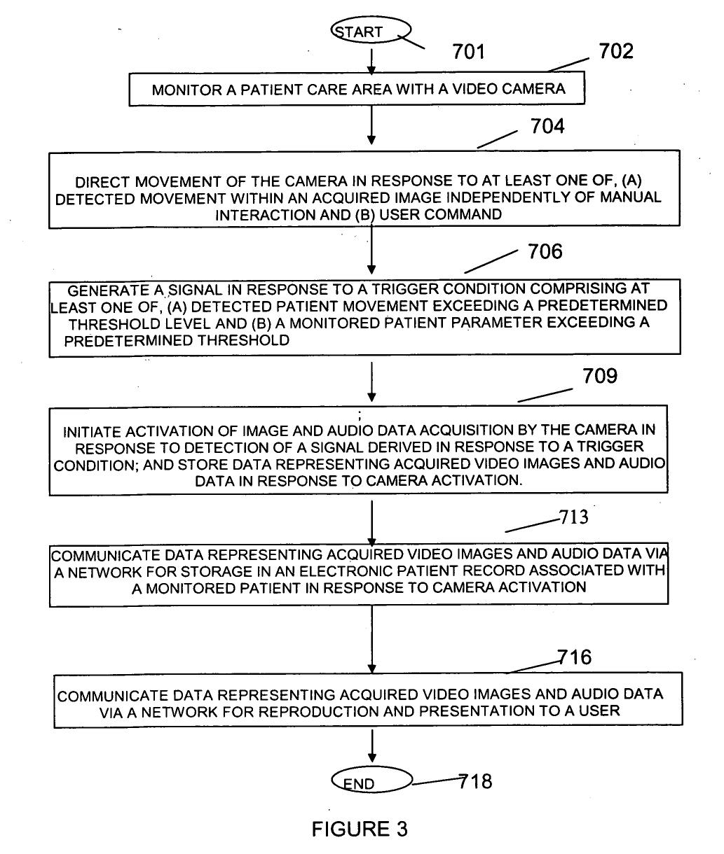

FIG. 3 shows a flowchart of process employed by executable application 500 in clinical information system 40 (FIG. 1) for managing a visual patient monitoring system. After the start at step 701, application 500 in step 702 uses the system of FIG. 1 in initiating monitoring of a patient care area with a video camera. The video camera monitors patient and healthcare worker behavior such as the physical administration of medication to a patient as well as care related items in the patient care area including medical devices.

In step 704, application 500 directs movement of the camera to view an area of interest in a care unit in response to detected movement within an acquired image and independently of manual interaction or user command. In step 706, a signal is generated in response to a trigger condition comprising, detected patient movement exceeding a predetermined threshold level and occurring during a predetermined time interval or after a predetermined time. The patient movement exceeding a predetermined threshold level is determined from at least one of, (i) image analysis and (ii) pixel luminance change. The signal may also be generated in response to a trigger condition comprising, an alert signal, a monitored patient parameter exceeding a predetermined threshold or a medical device generated trigger condition. Alternatively, the signal is generated during a predetermined time interval at a scheduled time. The time may be scheduled to occur on a single occasion or multiple occasions or on an intermittent or periodic basis.

In step 709, application 500 initiates activation of image data and audio data acquisition by the camera upon detection of the signal generated in response to a trigger condition in step 706 and communicated to the camera. Alternatively, in another embodiment, application 500 initiates activation of recording and storage of image data and audio data acquired by the camera in response to detection of the signal generated in response to a trigger condition. In another embodiment both camera and recording unit are activated in response to the signal generated in response to the trigger condition. In step 713, application 500 initiates communication of video and audio data acquired by a camera together with associated time identification data. The acquired video data shows a patient taking medication as verification of medication administration (and time of administration) to the patient, for example. The acquired data representing video and audio data is communicated via a network to an electronic patient record associated with a monitored patient for storage. In step 716 the data representing acquired video and audio information is communicated to a display for reproduction and presentation to a user. The process of FIG. 3 ends at step 718.

The systems and process presented in FIGS. 1-3 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the disclosed system may be implemented by those skilled in the art, without departing from the scope of the invention. Further, any of the functions provided by the system of FIGS. 1 and 2 may be implemented in hardware, software or a combination of both.

1. A system for remote monitoring of a patient, comprising:
a video camera positioned for monitoring a patient care area;
a camera management processor for initiating activation of image acquisition by said camera in response to detection of a signal derived in response to a trigger condition; and
a video recording unit for storing data representing acquired video images in response to camera activation.

2. A system according to claim 1, including
a communication interface for communicating data representing acquired video images via a network for storage in an electronic patient record associated with a monitored patient.

3. A system according to claim 2, wherein
said camera acquires audio information associated with acquired video information and
said communication interface communicates data representing acquired audio information via said network for storage in said electronic patient record associated with said monitored patient.

4. A system according to claim 1, including
a communication interface for communicating, data representing medication administration verification information indicating medication administered to a patient and associated administration times, via a network for storage in an electronic patient record associated with a monitored patient.

5. A system according to claim 1, including
a communication interface for communicating data representing acquired video images via a network for presentation on a display to a user.

6. A system according to claim 1, wherein
said signal is derived in response to a trigger condition comprising at least one of, (a) detected patient movement exceeding a predetermined threshold level and (b) a monitored patient parameter exceeding a predetermined threshold.

7. A system according to claim 1, wherein
said signal is derived in response to a trigger condition comprising at least one of, (a) an alert signal, and (b) detected movement in a patient room during a predetermined time interval or after a predetermined time and (e) a trigger condition generated by a medical device.

8. A system according to claim 1, wherein
said signal is derived in response to a trigger condition generated by a medical device.

9. A system according to claim 7, wherein
said patient movement exceeding a predetermined threshold level is determined from at least one of, (i) image analysis and (ii) pixel luminance change.

10. A system according to claim 1, wherein
said camera management processor directs movement of said camera in response to at least one of, (a) detected movement within an acquired image independently of manual interaction and (b) user command.

11. A system according to claim 1, wherein
said video camera monitors care related items in a patient care area including at least one of, (a) medical devices and (b) medication administration to a patient.

12. A system for remote monitoring of a patient, comprising:
a video camera positioned for monitoring a patient care area;
a camera management processor for initiating activation of image acquisition by said camera in response to detection of a signal derived in response to a trigger condition; and
a communication interface for communicating data representing acquired video images via a network for storage in an electronic patient record associated with, a monitored patient in response to camera activation.

13. A method for remotely monitoring a patient, comprising the activities of:
monitoring a patient care area with a video camera;
initiating activation of image acquisition by said camera in response to detection of a signal derived in response to a trigger condition; and
storing data representing acquired video images in response to camera activation.

14. A method according to claim 13, including the activity of
communicating data representing acquired video images via a network for storage in an electronic patient record associated with a monitored patient in response to camera activation

15. A method according to claim 13, including the activity of
generating said signal in response to a trigger condition comprising at least one of, (a) detected patient movement exceeding a predetermined threshold level and (b) a monitored patient parameter exceeding a predetermined threshold.

16. A method according to claim 13, including the activity of
generating said signal during a predetermined time interval.
